(19) United States
(12) Patent Application Publication
(10) Pub. No.: US 2010/0222443 A1
(43) Pub. Date: Sep. 2, 2010

(54) BLOWING AGENT COMPOSITION

(75) Inventors: Vincent Enaux, Bessenay (FR); Laurent Latil, Moidieu de Tourbes (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/294,685

(22) PCT Filed: Mar. 26, 2007
(86) PCT No.: PCT/FR2007/051010

§ 371 Date: Sep. 26, 2008

Related U.S. Application Data
(60) Provisional application No. 60/800,366, filed on May 15, 2006.

(30) Foreign Application Priority Data
Mar. 31, 2006 (FR) 0602796

(51) Int. Cl. C08J 9/00; C09K 3/00

(52) U.S. Cl. 521/113; 252/182.15; 521/131; 521/121; 521/129

(57) ABSTRACT

A subject-matter of the present invention is a blowing agent composition comprising an organic solvent with a boiling point, at atmospheric pressure, of greater than 0° C. and having a low GWP and at least one compound (C) chosen from haloketones, fluoroacids, fluoroesters, fluoroamines, (hydro)fluoroethers, (hydro) fluorothioethers, (hydro)fluoroolefins, cyclic (hydro)fluorocarbons and iodofluoro(hydro)carbons.

The present invention relates to a blowing agent composition capable of being used in the manufacture of thermoplastic and thermosetting foams.

In the field of thermoplastic and thermosetting foams, as in other applications, the Montreal protocol, which is targeted at limiting damage to the ozone layer, has imposed strict rules regarding the use of fluorinated products. The latter are characterized by their ODP (ozone depletion potential). CFCs (chlorofluorocarbons) were the first generation of products, HCFCs (hydrochlorofluorocarbons) the second, neither has a zero or negligible ODP. This is the case with the third generation of products, namely HFCs (hydrofluorocarbons). Moreover, these products are widely used to this day in the field of foams.

The ratification of the Kyoto protocol on the control of emissions of gases with a greenhouse effect is producing an additional constraint on these fluorinated products, namely a lowering in their GWP (global warming potential).

Thus, the use of at least one HFC as blowing agent in the manufacture of isocyanate-based foams has been described in Patent EP 381 986. Faced with increasingly strict environmental restrictions, the partial replacement of HFCs in the blowing agent composition has been suggested. The document WO 02/099006 discloses an azeotropic composition of HFC and of trans-1,2-dichloroethylene as blowing agent in the manufacture of foams.

The subject-matter of the present invention is the provision of a blowing agent composition which simultaneously satisfies the criteria of negligible ODP and of low GWP.

A first subject-matter of the present invention is a blowing agent composition comprising an organic solvent with a boiling point, at atmospheric pressure, of greater than 0° C. and having a low GWP, preferably of less than 100 or better still of less than 20, and at least one compound (C) chosen from haloketones, fluoroacids, fluoroesters, fluoroamines, (hydro)fluoroethers, (hydro)fluorothioethers, (hydro)fluoroolefins, cyclic (hydro)fluorocarbons and iodofluoro(hydro)carbons.

Advantageously, the blowing agent composition essentially comprises an organic solvent with a boiling point, at atmospheric pressure, of greater than 0° C. and having a low GWP, preferably of less than 100 or better still of less than 20, and at least one compound (C) chosen from haloketones, fluoroacids, fluoroesters, fluoroamines, (hydro)fluoroethers, (hydro) fluorothioethers, (hydro)fluoroolefins, cyclic (hydro)fluorocarbons and iodofluoro(hydro)carbons.

The blowing agent composition according to the present invention not only has a negligible ODP but also has a low GWP, preferably of less than 150.

This blowing agent composition preferably comprises from 1 to 99% by weight of solvent and from 99 to 1% by weight of compound(s) C. Advantageously, it comprises from 50 to 99% by weight of solvent and from 1 to 50% by weight of compound(s) C. The composition advantageously preferred comprises from 70 to 99% by weight of solvent and from 1 to 30% by weight of compound(s) C.

(Hydro)fluoroethers are preferably chosen as compound C.

(Hydro)fluoroethers denote compounds comprising carbon, fluorine, at least one ether functional group and optionally hydrogen.

Mention may in particular be made, as (hydro)fluoroethers, of those of general formula (Rₕ—O)ₓ—R_{f} in which x is equal to 1 or 2, Rₕ represents an optionally fluorinated alkyl group having from 1 to 4 carbon atoms and R_{f} represents a (per)fluorinated aliphatic group having at least 2 carbon atoms, preferably between 2 and 9 carbon atoms. R_{f} can also comprise heteroatoms, such as oxygen, nitrogen and sulphur.

The preferred hydrofluoroethers are those for which the value of x is equal to 1. Mention may in particular be made of 1-methoxynonafluorobutane, n-C₄F₉OCH₃, CF₃CF(CF₃)CF₂OCH₃ and (CF₃)₃COCH₃, and 1-ethoxynonafluorobutane, n-C₄F₉OC₂H₅, CF₃CF (CF₃) CF₂OC₂H₅ and (CF₃)₃COC₂H₅

The compounds with the following formulae may also be suitable as hydrofluoroethers: C₈F₁₇OCH₃, C₅F₁₁OC₂H₅, C₃F₇OCH₃ or 1,1-dimethoxyperfluorocyclohexane.

1-Methoxynonafluorobutane, n-C₄F₉OCH₃, CF₃CF (CF₃) CF₂OCH₃ and (CF₃)₃COCH₃, and 1-ethoxynonafluorobutane, n-C₄F₉OC₂H₅, CF₃CF(CF₃)CF₂OC₂H₅ and (CF₃)₃COC₂H₅, are advantageously chosen as hydrofluoroethers.

Mention may in particular be made, as organic solvent, of 1,1-dichloroethane, dioxolane, dimethyl carbonate, propylene carbonate, nonafluoro-tert-butanol, acetone, tert-butyl methyl ether, diisopropyl ether, diethyl ether, dipropyl ether, ethyl tert-butyl ether, 1,2-dimethoxyethane, dimethoxymethane, 1,1-dimethoxyethane, methanol, ethanol, n-propanol, isopropanol, n-butanol, s-butanol, t-butanol, ethyl propionate, ethyl acetate, ethyl formate, methyl acetate, methyl formate, propyl acetate, isopropyl acetate, isopentane, 2,2-dimethylbutane, 2,3-dimethylbutane, 2,3-dimethylpentane, 2-methylhexane, 3-methylhexane, 2-methylpentane, 3-ethylpentane, 3-methylpentane, cyclohexane, cyclopentane, n-heptane, methylcyclopentane, n-pentane, n-hexane, methylyl, 2-chloropropane, methylene chloride, ethylene chloride, trichloroethane, (methyl)tetrahydrofuran and formaldehyde dimethyl acetyl.

Dioxolane and dimethyl carbonate are advantageously chosen as organic solvent. Fluoroamines denote compounds comprising carbon, fluorine, at least one amine functional group and optionally hydrogen and chlorine. Mention may in particular be made of N-(difluoromethyl)-N,N-dimethylamine.

(Hydro)fluorothioethers denote compounds comprising carbon, fluorine, at least one thioether functional group and optionally hydrogen and chlorine. Mention may in particular be made of 1,1,1,2,2-pentafluoro-2-[(pentafluoroethyl)thio]ethane.

An example of cyclic (hydro)fluorocarbons is heptafluorocyclopentane.

Fluoroacids denote compounds comprising carbon, fluorine, at least one acid functional group and optionally hydrogen and chlorine.

Fluoroesters denote compounds comprising carbon, fluorine, at least one ester functional group and optionally hydrogen and chlorine.

Mention may in particular be made, as iodofluoro(hydro)carbons, of iodotrifluoromethane (CF₃I), iodopentafluoroethane (C₂F₅I), 1-iodoheptafluoropropane (CF₃CF₂CF₂I), 2-iodoheptafluoropropane (CF₃CFICF₃), iodo-1,1,2,2-tetrafluoroethane (CHF₂CF₂I), 2-iodo-1,1,1-trifluoroethane (CF₃CH₂I), iodotrifluoroethylene (C₂F₃I), 1-iodo-1,1,2,3,3,3-hexafluoropropane (CF₃CHFCF₂I) or 2-iodononafluoro-tert-butane ((CF₃)₃CI). Iodotrifluoromethane and iodopentafluoroethane are preferred.

Haloketones denote compounds comprising carbon, fluorine, at least one ketone functional group and optionally hydrogen, chlorine and bromine. Haloketones can be represented by the general formula R₁COR₂ in which R₁ and R₂, which are identical or different, are selected independently from the group consisting of aliphatic or alicyclic fluorocarbon radicals optionally comprising hydrogen, bromine or chlorine, it being possible for the chain of the carbon atoms of the radicals to be linear or branched and saturated or unsaturated. R₁ and R₂ can optionally form a ring. Haloketones can comprise from 3 to 10 carbon atoms, preferably from 4 to 8 carbon atoms. Haloketones can additionally comprise other heteroatoms, such as oxygen, in order to form an additional ketone functional group or an ether, aldehyde or ester group. Mention may in particular be made, as haloketones, of 1,1,1,2,2,4,5,5,5-nonafluoro-4-(trifluoromethyl)-3-pentanone, 1,1,1,2,4,5,5,5-octafluoro-2,4-bis(trifluoromethyl)-3-pentanone, 1,1,1,2,4,4,5,5-octafluoro-2-(trifluoromethyl)-3-pentanone, 1,1,1,2,4,4,5,5,6,6,6-undecafluoro-2-(trifluoromethyl)-3-hexanone, 1,1,2,2,4,5,5,5-octafluoro-1-(trifluoromethoxy-4-(trifluoromethyl)-3-pentanone, 1,1,1,3,4,4,4-heptafluoro-3-(trifluoromethyl)-2-butanone, 1,1,1,2,2,5,5,5-octafluoro-4-(trifluoromethyl)-3-pentanone or 2-chloro-1,1,1,4,4,5,5,5-octafluoro-2-(trifluoromethyl)-3-pentanone. 1,1,1,2,2,4,5,5,5-Nonafluoro-4-(trifluoromethyl)-3-pentanone is preferred.

Mention may also be made, as haloketones, of bromofluoroketones, for example monobromoperfluoroketones, monohydromonobromoperfluoroketones, (perfluoroalkoxy)monobromoperfluoroketones, (fluoroalkoxy)monobromoperfluoroketones and monochloromonobromoperfluoroketones.

Suitable (hydro)fluoroolefins are possibly 3,3,4,4,5,5,6,6,6-nonoafluoro-1-hexene or fluoropropenes of general formula CF₃CY═CXₙHₚ in which X and Y independently represent a hydrogen atom or a halogen atom chosen from fluorine, chlorine, bromine and iodine and n and p are integers having the value 0, 1 or 2 and such that (n+p) is equal to 2. Mention may be made, for example, of CF₃CH═CF₂, CF₃CH═CFH, CF₃CBr—CF₂, CF₃CH═CH₂, CF₃CF═CF₂, CF₃CCI—CF₂, CF₃CH_CHCI, CF₃CCI═CHF, CF₃CH═CCI₂ and CF₃CF═CCI₂.

1,1,1,3,3-Pentafluoropropene (HFO-1225zc), the cis and trans isomer of 1,1,1,3-tetrafluoropropene (HFO-1234ze) and 1,1,1,2-tetrafluoropropene (HFO-1234yf) are particularly preferred.

The blowing agent composition which is particularly preferred comprises 1,3-dioxolane and at least one hydrofluoroether. A blowing agent composition comprising 1,3-dioxolane and 1-methoxynonafluorobutane has given very advantageous results. The same applies for a composition comprising 1,3-dioxolane and 1-ethoxynonafluorobutane.

Mention may in particular be made, as other blowing agent composition which is particularly preferred, of that comprising dimethyl carbonate and at least one hydrofluoroether, such as 1-methoxynonafluorobutane and 1-ethoxynonafluorobutane.

The blowing agent composition according to the present invention advantageously results in thermoplastic and thermosetting foams having good dimensional stability. It is very particularly suitable for the manufacture of polyurethane foams and advantageously for the manufacture of rigid polyurethane foams.

In many applications, the components of the polyurethane foams are preblended. More generally, the formulation of the foams is preblended as two components. The first component, better known under the name “component A”, comprises the isocyanate or polyisocyanate composition. The second component, better known under the name “component B”, comprises the polyol or mixture of polyols, the surface-active agent, the catalyst or catalysts and the blowing agent or agents.

A second subject-matter of the present invention is thus a composition comprising a polyol or mixture of polyols and the blowing agent of the first subject-matter. The composition according to the second subject-matter is preferably in the form of an emulsion.

The blowing agent preferably represents between 1 and 60 parts by weight per 100 parts by weight of polyol or mixture of polyols in the composition of the second subject-matter. Advantageously, it represents between 5 and 35 parts by weight per 100 parts by weight of polyol or mixture of polyols.

Mention may in particular be made, as polyols, of glycerol, ethylene glycol, trimethylolpropane, pentaerythritol, polyether polyols, for example those obtained by condensing an alkylene oxide or mixture of alkylene oxides with glycerol, ethylene glycol, trimethylolpropane or pentaerythritol, or polyester polyols, for example those obtained from polycarboxylic acids, in particular oxalic acid, malonic acid, succinic acid, adipic acid, maleic acid, fumaric acid, isophthalic acid or terephthalic acid, with glycerol, ethylene glycol, trimethylolpropane or pentaerythritol.

The polyether polyols obtained by addition of alkylene oxides, in particular ethylene oxide and/or propylene oxide, to aromatic amines, in particular the 2,4- and 2,6-toluenediamine mixture, are also suitable.

Mention may in particular be made, as other types of polyols, of polythioethers comprising a hydroxyl ending, polyamides, polyesteramides, polycarbonates, polyacetals, polyolefins and polysiloxanes.

Another subject-matter of the present invention is a process for the manufacture of polyurethane foams. This process consists in reacting an organic polyisocyanate (including diisocyanate) with the composition according to the second subject-matter. This reaction can be activated using an amine and/or other catalysts and surface-active agents.

In addition to the blowing agent according to the present invention, the process for the manufacture of polyurethane foams can be carried out in the presence of a chemical blowing agent, such as water.

Mention may in particular be made, as polyisocyanate, of aliphatic polyisocyanates with a hydrocarbon group which can range up to 18 carbon atoms, cycloaliphatic polyisocyanates with a hydrocarbon group which can range up to 15 carbon atoms, aromatic polyisocyanates with an aromatic hydrocarbon group having from 6 to 15 carbon atoms and arylaliphatic polyisocyanates with an arylaliphatic hydrocarbon group having from 8 to 15 carbon atoms.

The preferred polyisocyanates are 2,4- and 2,6-diisocyanatotoluene, diphenylmethane diisocyanate, polymethylene polyphenyl isocyanate and their mixture. Modified polyisocyanates, such as those comprising carbodiimide groups, urethane groups, isocyanurate groups, urea groups or diurea groups, may also be suitable.

### EXPERIMENTAL PART

Procedure for the preparation of a rigid polyurethane foam.

100 parts by weight of polyol Stepanpol PS2412 (polyester type), 1.5 parts by weight of surface-active agent Tegostab B8465, 3 parts by weight of water and 10 parts by weight of the blowing agent composition in accordance with the invention are introduced into a beaker. The resulting mixture is then stirred for one minute using a vertical mechanical stirrer at a mean speed of 2000 rev/min.

110 parts by weight of Desmodur 44V70L (isocyanate) are subsequently introduced into the beaker and stirring is carried out for 15 seconds with a mean speed of 3500 rev/min.

While stirring the mixture, the catalyst, composed of 2.82 parts by weight of Dabco K15 (mixture of potassium salt of 2-ethylhexanoic acid and of diethylene glycol) and 0.18 part by weight of Polycat 5 (pentamethyldiethylenetriamine), is injected using a plastic syringe. After stirring for 25 seconds (total), the mixture is poured into a rectangular mould covered with paper. There is then a wait of 5 minutes before removing the foam from the mould and, after 24 h, the foam is cut up using a bandsaw.

The volume of the cut-up foam is measured before passing into the oven and after 72 h at 70° C. in the oven.

The difference between the volume of the foam after and before passing into the oven gives an indication of the dimensional stability and the data are given in the table below.

The difference in volume, expressed as percentage, is calculated in the following way: difference in volume (%)=(final volume−starting volume)/starting volume.

The blowing agents used for the examples are as follows:
example 1 (in accordance with the invention): 75% by weight of dimethyl carbonate (DMC) and 25% by weight of 1-methoxynonafluorobutane
example 2 (in accordance with the invention): 75% by weight of 1,3-dioxolane and 25% by weight of 1-methoxynonafluorobutane.

| | | | | | Foam | |
|---|---|---|---|---|---|---|
| | Dimension | | Thickness | Volume | volume | |
| | before | | before | before | after | Difference |
| | stoving | | stoving | stoving | stoving | in volume |
| | (cm) | | (cm) | (cm³) | (cm³) | (%) |
| Example 1 | 10.10 | 10.10 | 3.00 | 306.03 | 391.00 | 27.77 |
| Example 2 | 9.90 | 9.90 | 3.00 | 294.03 | 365.00 | 24.14 |
| 1,3-Dioxolane | 9.90 | 9.90 | 3.00 | 294.03 | 76.00 | −74.15 |
| DMC | 10.10 | 10.10 | 2.95 | 300.93 | 68.00 | −77.40 |

1. Blowing agent composition comprising an organic solvent with a boiling point, at atmospheric pressure, of greater than 0° C. and having a low GWP and at least one compound (C) selected from the group consisting of haloketones, fluoroacids, fluoroesters, fluoroamines, (hydro)fluoroethers, (hydro)fluorothioethers, (hydro)fluoroolefins, cyclic (hydro)fluorocarbons and iodofluoro(hydro)carbons.

2. Composition according to claim 1, characterized in that it comprises from 1 to 99% by weight of said organic solvent and from 99 to 1% by weight of compound C.

3. Composition according to claim 1, characterized in that it further comprises a polyol or a mixture of polyols.

4. Composition according to claim 1, characterized in that the organic solvent is selected from the group consisting of dioxolane and dimethyl carbonate.

5. Composition according to claim 1, characterized in that the compound C is selected from the group consisting of 1-methoxynonafluorobutane, 1-ethoxynonafluorobutane and mixtures thereof.

6. Composition according to claim 3, characterized in that the blowing agent is present in a proportion of 1 to 60 parts by weight, per 100 parts by weight of polyol.

7. Process for the manufacture of foams, characterized in that use is made of the blowing agent according to claim 1.

8. Process for the manufacture of polyurethane foams, characterized in that use is made of a composition according to claim 1.

9. Blowing agent composition according to claim 1, characterized in that said GWP is less than 100.

10. Blowing agent composition according to claim 1, characterized in that said GWP is less than 20.

11. Composition according to claim 1, characterized in that it comprises from 50 to 99 parts by weight of said organic solvent and from 1 to 50% by weight of compound C.

12. Composition according to claim 1, characterized in that it comprises from 70 to 99% by weight of said solvent and 1 to 30% by weight of compound C.
